(19) United States
(12) Patent Application Publication
(10) Pub. No.: US 2024/0412104 A1
(43) Pub. Date: Dec. 12, 2024

(54) MODEL TRAINING USING AUGMENTED DATA FOR MACHINE LEARNING SYSTEMS AND APPLICATIONS

(71) Applicant: NVIDIA Corporation, Santa Clara, CA (US)

(72) Inventors: Dong ZHANG, Churchill, TN (US); Tae Eun CHOE, Belmont, CA (US); Seungwoo YOO, Yongin (KR); Sangmin OH, San Jose, CA (US); Minwoo PARK, Saratoga, CA (US)

(21) Appl. No.: 18/333,519

(22) Filed: Jun. 12, 2023

(51) Int. Cl. G06N 20/00

(52) U.S. Cl. CPC G06N 20/00

(57) ABSTRACT

Systems and methods are disclosed that relate to training a machine learning system using simulated objects. A simulated object may be generated based at least on extracting at least a portion of the simulated object from a simulated textured representation. Further, the simulated anomaly object may be combined with an existing image to generate a training image. One or more parameters of a machine learning model may be updated based at least on the training image and ground truth data corresponding to the training image.

### BACKGROUND

Machine learning systems have become increasingly vital to various system and applications. In general, a machine learning system or neural network (e.g., a deep neural network (DNN)) learns, or may be trained, to make determinations based on a training data set that may include real world and/or simulated examples of an environment associated with the machine learning system. For example, a machine learning system used with an autonomous machine operation may be configured to detect other objects (e.g., other vehicles) in a driving setting (e.g., on a roadway) by having previously been trained using a training data set that may include a diverse number of objects (e.g., vehicles) in a variety of different driving settings.

In some traditional implementations, the training data set may include many (e.g., thousands, tens of thousands, or more) different samples of data elements on which the machine learning system may be being trained. The effectiveness and/or accuracy of the machine learning system, such as predicting and/or correctly detecting a data element in an environment may be related to a number of instances of the data element in the training data set and the variety of instances of the data element. For example, in instances in which a data element appears more often in a first training data set compared to the data element in a second data set, a machine learning system may more accurately and/or with a greater confidence predict and/or detect the data element in an environment when trained with the first training data set compared to being trained with the second training data set. As such, traditional implementations may be limited in detecting many data elements in an environment as many data elements may occur infrequently and/or may be absent from training images.

### SUMMARY

Embodiments of the present disclosure relate to applications and systems for training a machine learning system using simulated anomaly objects such that the machine learning system may detect an anomaly object in an operating environment. Systems and methods are disclosed that relate to generating a simulated object that may be distinct from an operating environment. The simulated object may be an abstract object, that may appear to be nonsensical or otherwise unlike existing anomaly objects. Alternatively, or additionally, the simulated object may include one or more randomly generated features. For example, the simulated object may be extracted from a portion of a simulated textured representation. Further, the simulated object may be combined with an existing image (e.g., an existing image of the operating environment) to generate a training image. Further, the training image may be provided to the machine learning system where the training image may be used to train the machine learning system to detect the anomaly object in the operating environment. For example, one or more parameters of the machine learning model may be updated based at least on the training image and ground truth data corresponding to the training image. As such, the machine learning system may detect anomaly objects in the operating environment in instances in which existing machine learning systems may be unable to in view of the lack of training data that may be available for the machine learning system.

### BRIEF DESCRIPTION OF THE DRAWINGS

The present systems and methods for training a machine learning system using simulated anomaly objects are described in detail below with reference to the attached drawing figures, wherein:

FIG. 1 illustrates an example environment configured for training a machine learning system using simulated anomaly objects, according to one or more embodiments of the present disclosure;

FIG. 2A illustrates a method for training a machine learning system using simulated anomaly objects, according to one or more embodiments of the present disclosure;

FIG. 2B illustrates components of the method for training a machine learning system using simulated anomaly objects, as described relative to FIG. 2A;

FIG. 3 illustrates a method for training a machine learning system using simulated anomaly objects, according to one or more embodiments of the present disclosure;

FIG. 4A is an illustration of an example autonomous vehicle, in accordance with some embodiments of the present disclosure;

FIG. 4B is an example of camera locations and fields of view for the example autonomous vehicle of FIG. 4A, in accordance with some embodiments of the present disclosure;

FIG. 4C is a block diagram of an example system architecture for the example autonomous vehicle of FIG. 4A, in accordance with some embodiments of the present disclosure;

FIG. 4D is a system diagram for communication between cloud-based server(s) and the example autonomous vehicle of FIG. 4A, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods disclosed herein may relate to training a machine learning system using simulated anomaly objects. The training may be such that the machine learning system may be improved in its ability to detect the presence of anomalous objects in an environment. For example, in some embodiments, the machine learning system trained in such a manner may be used with respect to an ego-machine such that the ego-machine may better detect potential obstacles or hazards while navigating within an environment. For example, because any object in a roadway of a vehicle or a pathway of a robot may present a hazard, it may be difficult to generate enough real world training data that depicts actual hazards in roadways or pathways that can be used to train a machine learning model to accurately predict (e.g., detect, classify, identify, etc.) hazard objects. As such, the systems and methods of the present disclosure may be used to simulate hazards that may be included in simulated data or real world data (e.g., as augmented data) to help increase the robustness of a training data set for training a machine learning model.

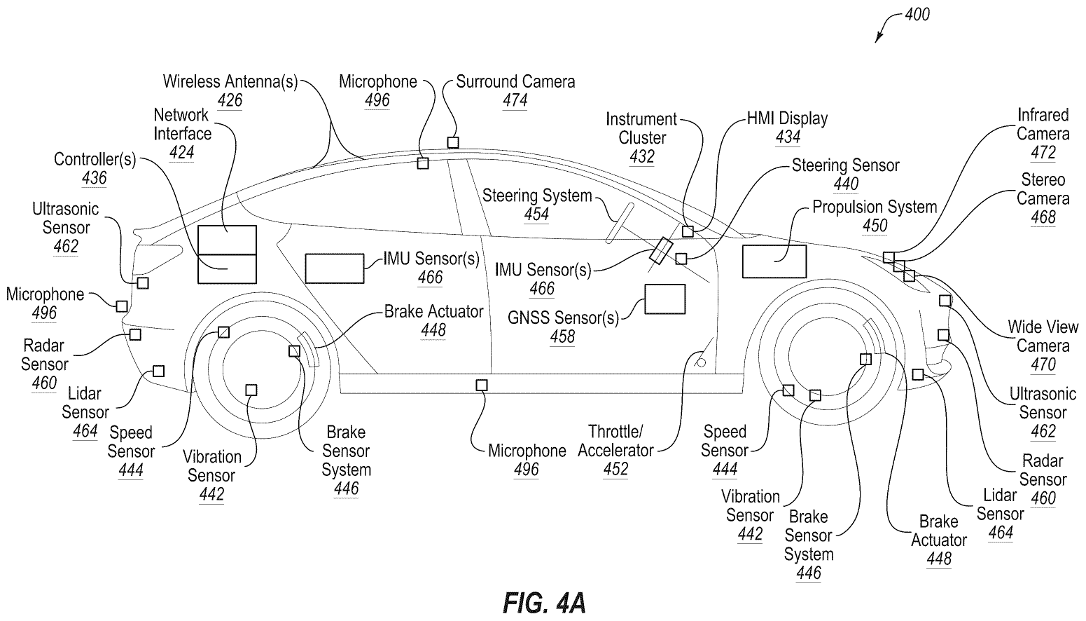

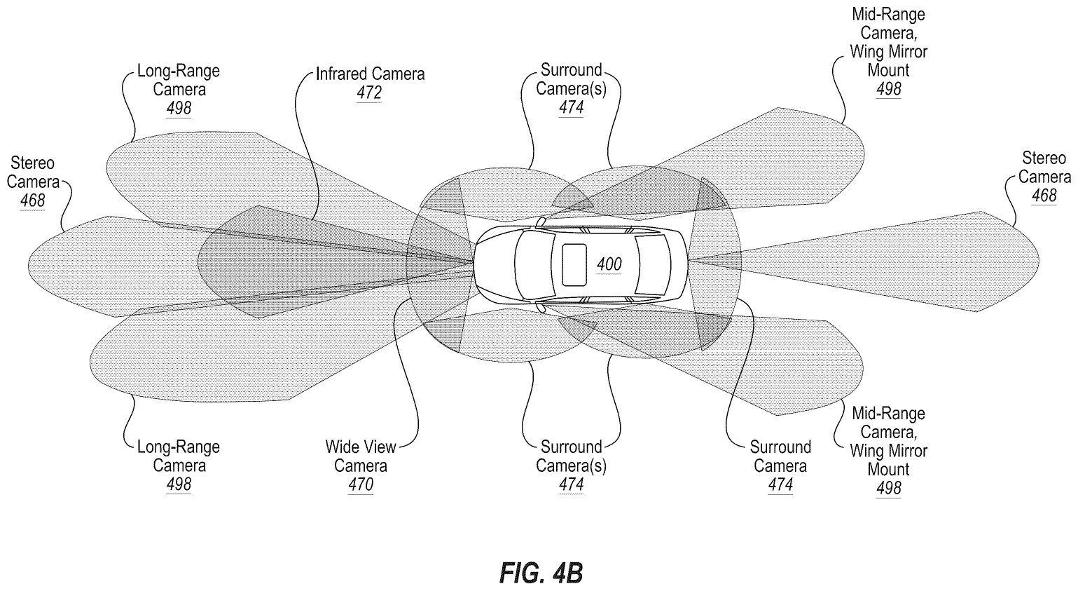

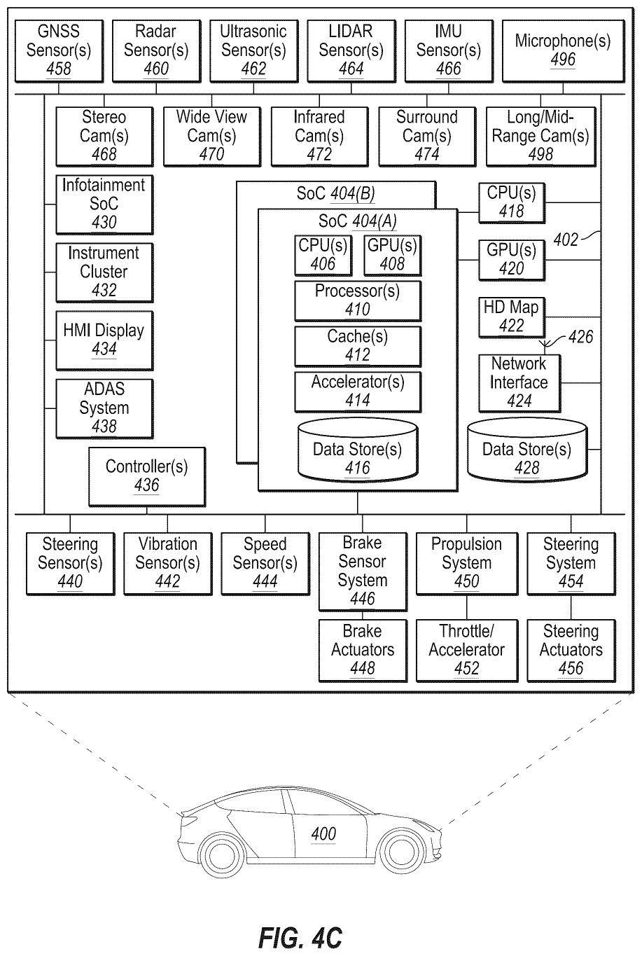

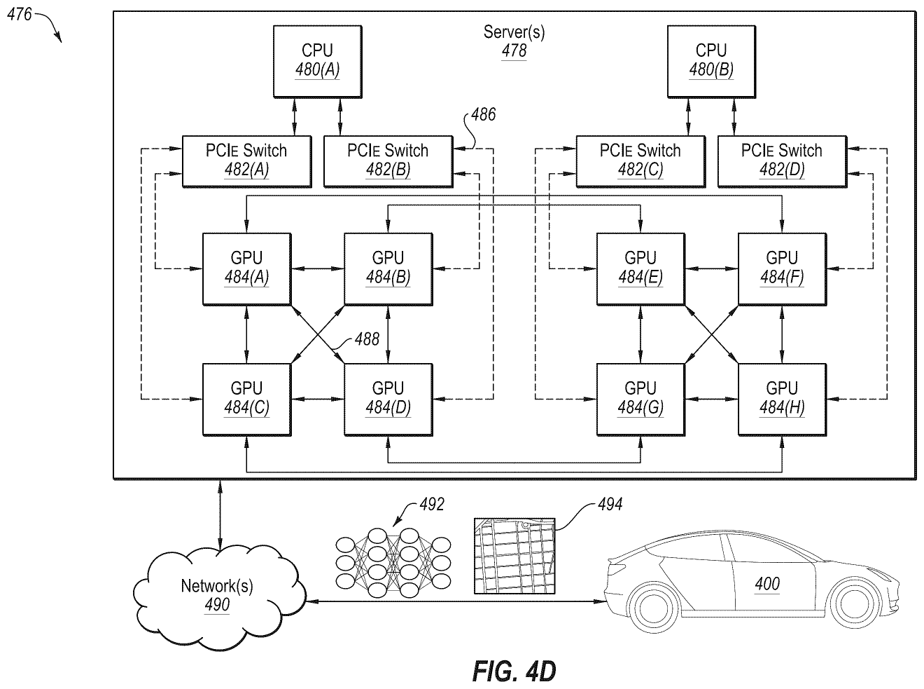

In the present disclosure, an “ego-machine” may include any applicable machine or system that is capable of performing one or more autonomous and/or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous or semi-autonomous vehicle or machine 400 (alternatively referred to herein as “vehicle 400” or “ego-machine 400) described with respect to FIGS. 4A-4D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

Alternatively, or additionally, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs) that may process text, audio, and/or image/sensor data to generate one or more outputs, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

In some circumstances, an operating environment may include one or more data elements that may occur sporadically, infrequently, or hypothetically, where such data elements may be considered an anomalous data object, or an anomaly object. An anomaly object may be difficult to include and/or capture in a training data set as the infrequency of the anomaly object in the training data set may hinder a machine learning system from receiving a threshold number of iterations of the anomaly object to improve the reliability of detection of the anomaly object in the operating environment. For example, in instances in which the operating environment is a roadway or other drivable surface for a vehicle, an anomaly object may include, but not be limited to, broken car parts, a mattress, traffic cones, large rocks or boulders, ladders, trash, animal remains, rocket debris, and/or other objects that may not readily be present in the roadway. Although primarily described as objects herein, the present systems and methods may also be used to help a machine learning model identify hazardous features of a road, such as potholes, undulations, depressions, and/or other road or pathway hazards.

Alternatively, or additionally, a training data set may include one or more anomaly objects therein, where individual anomaly objects may individually contribute to the machine learning system learning to detect the anomaly objects in the operating environment. In instances in which a first anomaly object is more present in the training data set than a second anomaly object, the machine learning system may detect the first anomaly object as an anomaly object in the operating environment more accurately and/or more often than the second anomaly object, which may introduce a bias in the machine learning system toward detecting the first anomaly object as an anomaly object in the operating environment relative to the second anomaly object. For example, a road cone and animal remains may individually be anomaly objects in an operating environment (e.g., a roadway for vehicles) that may be included in a training data set for a machine learning system, and where the road cone may be more common in the operating environment than the animal remains in the operating environment, the machine learning system may be biased toward detecting the road cone as an anomaly object and not detecting the animal remains as an anomaly object. As such, the machine learning system may be less likely to detect animal remains as an anomaly object in an operating environment after receiving training from the training data set than detecting a road cone as an anomaly object in the operating environment. In the same example, if a hazard that was not included in the training data set—such as a ladder—is depicted in an image during deployment of the machine learning model, the model may not identify the ladder as a hazard object at all.

In general, a machine learning system may be biased away from detecting less common and/or less prevalent anomaly objects as anomaly objects relative to more common anomaly objects that may be encountered in an operating environment as the training data set may be obtained from existing operating environments, where some anomaly objects may be less prevalent than other anomaly objects. In some circumstances, a machine learning system may be less likely and/or unable to detect a particular anomaly object as an anomaly object in the operating environment as the particular anomaly object may be absent from a training data set. For example, in instances in which an anomaly object in an operating environment is rocket debris, and where the anomaly object may not be included in a training data set (e.g., due to a scarcity of the rocket debris occurring in an operating environment), an associated machine learning system training on the training data set may not be configured to detect the anomaly object (e.g., the rocket debris) as an anomaly object in the operating environment and/or may detect the anomaly object with a low degree of confidence (e.g., fifty percent and/or lower).

In some embodiments, a machine learning system may fail to detect one or more anomaly objects as an anomaly object within the operating environment, which may be due, in part, to the biases introduced through the training data set and/or the lack of the anomaly object being present in the training data set. In general, the machine learning system may detect the one or more anomaly objects using various object detection techniques, but the machine learning system may fail to detect the one or more anomaly objects as an anomaly object relative to the operating environment. In such instances, the machine learning system may fail to take any actions in response to the anomaly objects, which may present risks and/or issues to the machine learning system, systems and/or devices associated with the machine learning system, and/or various objects within the operating environment. For example, in instances in which a machine learning system is associated with an autonomous machine in a drivable environment, failing to detect a bed frame as an anomaly object may result in less than ideal responsive actions-such as coming to a complete stop, rather than navigating slowly around the object. In another example, in instances in which a machine learning system is associated with integrated circuit fabrication, failing to detect a damaged electrical connection between two components may result in one or more aspects of the integrated circuit malfunctioning and/or may result in degraded and/or inaccurate performance by the integrated circuit.

In some embodiments of the present disclosure, a training data set may be generated for use by a machine learning system where the training data set may include one or more simulated anomaly objects and/or other generated objects within an operating environment. In some embodiments, the simulated anomaly objects may not be included in a class of objects that may be associated with an operating environment in which the machine learning system being trained may be configured to operate. For example, in instances in which the operating environment is a roadway and/or other drivable surface, the simulated anomaly object may be an object that may not be readily detected by the machine learning system as a particular type of object—e.g., the simulated anomaly object may not be classified as a road cone, a garbage can, rocks, and/or other objects that may typically be located within the operating environment. Alternatively, or additionally, the simulated anomaly objects may be included in a class of objects that may be disposed within an operating environment. Referring to the previous example, the simulated anomaly objects may include one or more of a road cone, a garbage can, rocks, and/or other objects that may typically occur within the operating environment (e.g., a roadway and/or other drivable surfaces). In general, the simulated anomaly objects may be classified in a general class of objects where the simulated anomaly objects may be detected as an anomaly object, but not readily classified into a known class of objects. In some embodiments, the general class of objects may include any object detected as anomalous and that may not be detected as being in a similar class of other known objects and/or anomaly objects.

In general, the simulated anomaly objects included in the training data set may be any object that a machine learning system may be configured to detect as anomalous, which may include any object that may be unexpected, uncommon, and/or unrecognized within the operating environment. A simulated anomaly object may be generated by randomly generating a shape for the simulated anomaly object. Alternatively, or additionally, the simulated anomaly object may include a textured surface that may be randomly generated, where a particular pixel within the textured surface may be related to pixels adjacent to the particular pixel. Alternatively, or additionally, a random shade may be generated and combined with the textured surface to obtain a random object part. In some embodiments, one or more random object parts may be combined to form the simulated anomaly object. In general, the simulated anomaly object may be an abstract object that may include one or more randomly generated features, which may include the randomly generated shape, the randomly generated textured surface, a random combination of shapes and/or surfaces, and/or random combination of random objects, as described herein. The simulated anomaly object may be considered abstract in that the simulated anomaly object may appear nonsensical and/or may not have an appearance comparable to other real world objects or features that may be located in an operating environment.

In some embodiments, the simulated hazard or anomaly object may be combined with an existing image of the operating environment to form an augmented training image that may be included in a training data set for a machine learning system. The process of generating a simulated anomaly object may be repeated until many diverse training images (e.g., thousands, tens of thousands, hundreds of thousands, or more) may be included in the training data set, which may then be used to train the machine learning system. Using the training data set that includes the training images, a machine learning system may be configured to detect an anomaly object within an operating environment, which may be without regard to a frequency in which an anomaly object may occur naturally. For example, a machine learning system configured to operate in a drivable environment and trained using the training data set that includes one or more simulated anomaly objects may be configured to detect rocket debris in the operating environment, where the rocket debris may rarely occur naturally in the operating environment.

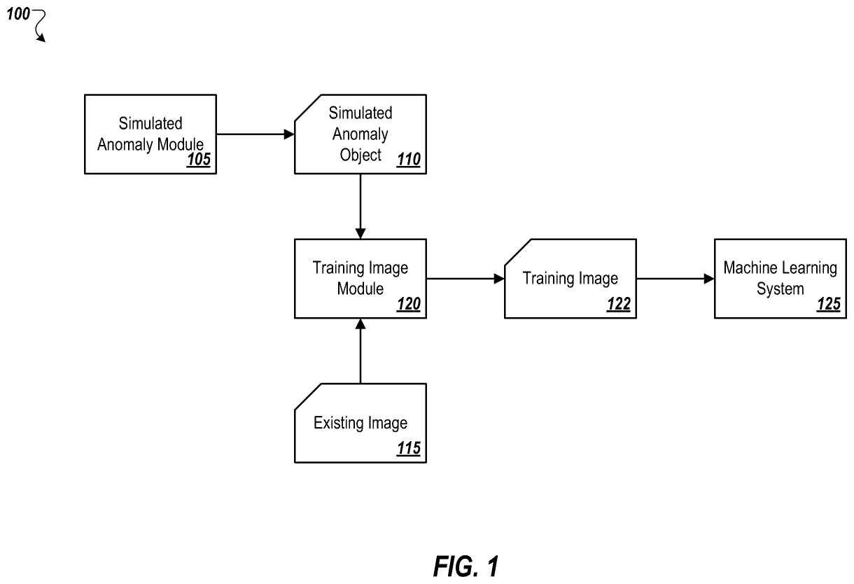

Referring now to FIG. 1, FIG. 1 illustrates an example environment 100 for training a machine learning system 125 to perform anomaly object detection, according to one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed using entities may be carried out using hardware, firmware, and/or software. For instance, various functions may be carried out using a processor executing instructions stored in memory.

In some embodiments, the environment 100 may include a simulated anomaly object module 105, a training image module 120, and the machine learning system 125. In some embodiments, the machine learning system 125 may be operable in various operating environments, including operating environments in which training data for the machine learning system 125 may be sparse and/or nonexistent, by using a simulated anomaly object 110 generated using the anomaly object module 105 and the operations for training the machine learning system 125 as described herein. As disclosed, one or more aspects of the environment 100 may train the machine learning system 125 to detect one or more anomaly objects within the operating environment where the one or more anomaly objects may be uncommon and/or absent from a set of training data.

In some embodiments, the operating environment may include any location and/or setting in which an anomaly object may be located. Alternatively, or additionally, the operating environment may include a location captured in an existing image 115, as described herein. For example, the operating environment may include a driving environment including a drivable surface and/or objects within the driving environment including other vehicles, pedestrians, construction equipment, signs, poles, etc. In another example, the operating environment may include one or more aspects of an integrated circuit including semiconductor material, transistors, electrical connections, etc. In another example, the operating environment may include a space environment including natural satellites, artificial satellites, space debris, etc.

In these and other embodiments, the machine learning system 125 may be trained to detect anomaly objects prior to being deployed in the operating environment (which may include using an existing image 115 of the operating environment) using a training image 122 including the simulated anomaly object 110 combined with the existing image 115 as described herein. Alternatively, or additionally, the machine learning system 125 may receive training (e.g., additional training) using the training image 122 while deployed in the operating environment. For example, subsequent to an initial training of the machine learning system 125 and deployment in the operating environment, the machine learning system 125 may obtain additional training images 122 and may continue to train which may improve accuracy and/or performance of the machine learning system 125.

In these and other embodiments, the environment 100 may include a simulated anomaly object 110 generated via the simulated anomaly object module 105 and training image module 120 may combine the simulated anomaly object 110 with the existing image 115 to form the training image 122. The training image 122 may be used to train the machine learning system 125 to detect anomaly objects that may be present in the operating environment. As such, training the machine learning system 125 with the training image 122, as described, may allow the machine learning system 125 to detect various anomaly objects in the operating environment, where some anomaly objects may be uncommon and/or absent from typical training images (e.g., such as training images that include only existing image 115 and/or the anomaly objects located within the existing image 115).

In instances in which a particular anomaly is uncommon and/or absent from the operating environment (and by extension, traditional training data based on the operating environment), other machine learning systems trained on the traditional training data may fail to detect the particular anomaly. For example, in a driving environment, a particular anomaly may be rocket debris (which may be an uncommon anomaly in the driving environment) and the rocket debris may be absent from the training data, such that the other machine learning systems trained with existing training data may fail to detect the rocket debris.

Alternatively, or additionally, in instances in which a first anomaly occurs infrequently in traditional training data relative to a second anomaly, the other machine learning systems may be biased toward the second anomaly, such that the other machine learning systems may more often and/or more accurately detect the second anomaly compared to the other machine learning systems detecting the first anomaly. For example, in a driving environment, a first anomaly may be an airbag and a second anomaly may be a construction cone where construction cones may be more prevalent relative to airbags in traditional training data. As such, the other machine learning systems may detect a construction cone due to the presence of the construction cones in the traditional training data and/or the other machine learning systems may fail to detect the airbag due to a lack of airbags present in the traditional training data.

In some embodiments, the simulated anomaly object module 105 may include code and routines configured to allow one or more computing devices to perform one or more operations. Additionally, or alternatively, the simulated anomaly object module 105 may be implemented using hardware including one or more processors, central processing units (CPUs), graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators), programmable vision accelerators (including one or more direct memory address (DMA) systems and/or vector processing units (VPUs)), and/or other processor types. In some other instances, the simulated anomaly object module 105 may be implemented using a combination of hardware and software. In the present disclosure, operations described as being performed using the simulated anomaly object module 105 may include operations that the simulated anomaly object module 105 may direct a corresponding system to perform.

In some embodiments, the simulated anomaly object module 105 may generate the simulated anomaly object 110, where the simulated anomaly object 110 may be distinct from the operating environment. The simulated anomaly object 110 may be an abstract object, that may include one or more randomly generated features. The simulated anomaly object 110 may be abstract in that the simulated anomaly object 110 may appear to be visually nonsensical and/or unlike any object (anomaly object or otherwise) that may appear in the operating environment. As described herein, the machine learning system 125 may be trained by detecting the simulated anomaly object 110 included in the training image 122 to subsequently detect an anomaly object in an operating environment by determining that the anomaly object is out of place relative to the operating environment.

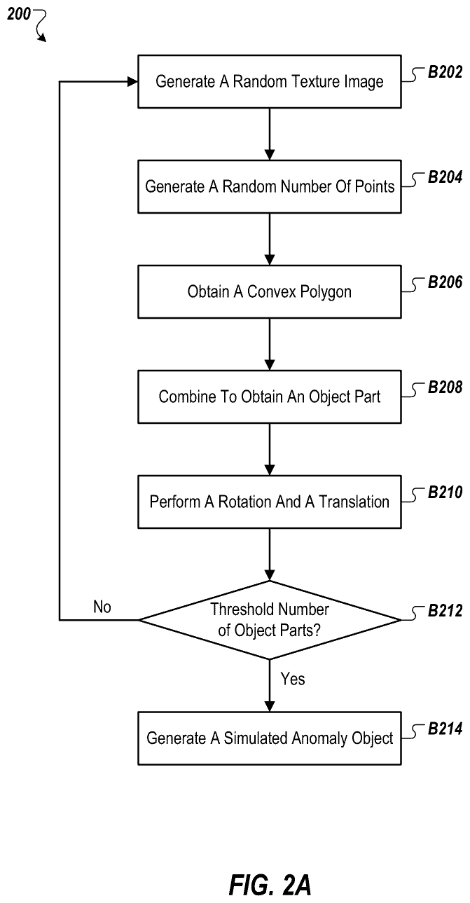

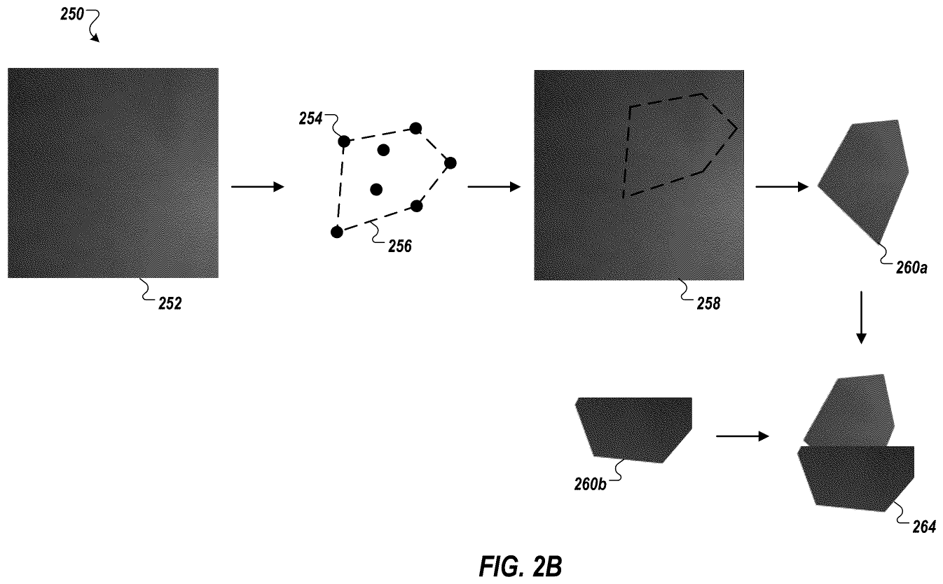

In some embodiments, the simulated anomaly object 110 may be a generated object that may include a random texture (which may include random color), a random shape, random number of object parts, and/or other characteristics, that may be described herein relative to the method 200 of FIG. 2A. As such, in some embodiments, the simulated anomaly object 110 may include one or more different textures, colors, shapes, sizes, etc. relative to objects (e.g., anomaly object or otherwise) that may be included in an operating environment. In some embodiments, the simulated anomaly object 110 may be distinct from the operating environment and/or may be distinct from objects generally included in the operating environment. For example, in instances in which the operating environment is a driving environment, the simulated anomaly object 110 may include a texture and/or shape that may be distinct from at least a driving surface (e.g., a driving surface material such as concrete, asphalt, dirt, etc.), an automobile, a pedestrian, road signage, a curb, and/or other objects that may routinely be present in the driving environment.

In these and other embodiments, the simulated anomaly object module 105 may generate the simulated anomaly object 110 such that the simulated anomaly object 110 may be distinct from a portion of the operating environment at which the simulated anomaly object 110 may be disposed. For example, in instances in which the operating environment is a driving environment, the simulated anomaly object 110 may be distinct from portions of the driving surface such that a difference may exist between the simulated anomaly object 110 and the portions of the operating environment in the existing image 115 that may be used to train the machine learning system 125.

In some embodiments, the simulated anomaly object module 105 may generate the simulated anomaly object 110 separate from the operating environment and/or the existing image 115, such that the simulated anomaly object 110 may not be related to and/or based on the operating environment (e.g., prior to being combined with the existing image 115 and included in the training image 122). For example, the simulated anomaly object module 105 may generate the simulated anomaly object 110 in a blank canvas which may not include consideration relative to an appearance the operating environment and/or the existing image 115.

In some embodiments, the simulated anomaly object 110 may include one or more object parts that may be combined together to form the simulated anomaly object 110. In some embodiments, the one or more object parts of the simulated anomaly object 110 may be iteratively combined until an anomaly threshold associated with the simulated anomaly object 110 and/or the operating environment is satisfied. The anomaly threshold may be predetermined (e.g., a configurable and/or predetermined number of object parts may be included in the simulated anomaly object 110) and/or the anomaly threshold may be determined in response to one or more factors associated with the simulated anomaly object 110 and/or the operating environment. For example, one or more object parts may be combined until the simulated anomaly object 110 satisfies an area threshold within the canvas. In some embodiments, the area threshold may be associated with a ground truth mask as described herein. For example, the simulated anomaly object 110 may be sized relative to an area constrained by the ground truth mask, such that the simulated anomaly object 110 may be substantially the same size or smaller than the ground truth mask. In another example, one or more object parts may be combined until the simulated anomaly object 110 satisfies a threshold size relative to the operating environment and/or the existing image 115. In some embodiments, the size threshold may be associated with a size of objects within the existing image 115, the perspective and/or perceived depth of the location of the simulated anomaly object 110 when combined with the existing image 115, a threshold number of pixels that may be allocated for the simulated anomaly object 110, etc. For example, a first threshold size may be assigned to the simulated anomaly object 110 when the simulated anomaly object 110 is a first distance from a viewer of the existing image 115 and a second threshold size may be assigned to the simulated anomaly object 110 when the simulated anomaly object is a second distance from the viewer of the existing image 115, where the second distance appears further from the viewer compared to the first distance (e.g., the second distance has a greater depth than the first distance).

In some embodiments, the simulated anomaly object module 105 may generate at least one simulated anomaly object 110 for an individual existing image 115 and/or the simulated anomaly object module 105 may generate more than one simulated anomaly object 110 for an individual existing image 115. For example, in instances in which there are one hundred existing images 115 in the environment 100, one hundred or more simulated anomaly objects 110 may be generated using the simulated anomaly object module 105 such that the existing images 115 may individually include at least one simulated anomaly object 110. In these and other embodiments, the simulated anomaly object module 105 may generate at least N simulated anomaly objects 110 in response to N existing images 115 included in the environment 100, where the ratio of the number of simulated anomaly objects 110 relative to the number of existing images 115 may be 1:1 or greater (e.g., 1.5:1, 2:1, or generally N+M:N, where M may include zero or any positive value).

In these and other embodiments, the training image module 120 may obtain the simulated anomaly object 110 and the existing image 115 and the training image module 120 may combine the simulated anomaly object 110 and the existing image 115 to form the training image 122. Alternatively, or additionally, the training image module may provide the training image 122 to the machine learning system 125 to train the machine learning system 125 to detect anomaly objects in the training image 122 and/or in a future operating environment (e.g., after the machine learning system 125 is trained). In some embodiments, multiple training images 122 may be formed by the training image module 120 by combining multiple simulated anomaly objects 110 with multiple existing images 115. Further, the training image module 120 may provide the multiple training images 122 to the machine learning system 125 as a training data set. For example, hundreds, thousands, tens of thousands, hundreds of thousands, or more training images may be provided from the training image module 120 to the machine learning system 125 to train the machine learning system 125 to detect an anomaly object in an operating environment.

In some embodiments, the training image module 120 may include code and routines configured to allow one or more computing devices to perform one or more operations. Additionally, or alternatively, the training image module 120 may be implemented using hardware including one or more processors, central processing units (CPUs), graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators), PVAs, and/or other processor types. In some other instances, the training image module 120 may be implemented using a combination of hardware and software. In the present disclosure, operations described as being performed using the training image module 120 may include operations that the training image module 120 may direct a corresponding system to perform.

In some embodiments, the combination of the simulated anomaly object 110 and the existing image 115 by the training image module 120 to form the training image 122 may be performed automatically. For example, in response to identifying that a particular training image 122 has not yet been generated for a particular existing image 115 (e.g., such as by the training image module 120), a simulated anomaly object 110 may be generated by the simulated anomaly module 105 and obtained by the training image module 120, which may automatically combine the simulated anomaly object 110 with the existing image 115 to form the particular training image 122. Alternatively, or additionally, the training image module 120 may obtain one or more existing anomaly objects and may combine the existing anomaly objects with the existing image 115 (e.g., in addition to the simulated anomaly object 110) to form the training image 122, such that the training image 122 generated by the training image module 120 may include at least one simulated anomaly object 110 and/or an existing anomaly object. The existing anomaly objects may include any object that may be commonly found in the corresponding operating environment. For example, in a driving environment, the existing anomaly object may include a construction cone, a garbage can, rocks, and/or other objects that may be found on or near a roadway. In another example, in an integrated circuit manufacturing environment, the existing anomaly object may include misplaced transistors, imperfections in the semiconductor material, and/or other objects that may be found in an integrated circuit.

In some embodiments, a location of the simulated anomaly object 110 relative to (e.g., within) the existing image 115 may be limited and/or restricted by the training image module 120. For example, in instances in which the existing image 115 is a driving environment, the training image module 120 may restrict the location of the simulated anomaly object 110 within the existing image 115 to a drivable surface within the driving environment (e.g., a roadway and not a sidewalk, a building, the sky, etc.). In these and other embodiments, the existing image 115 may include a ground truth mask that may direct one or more object locations within the operating environment depicted by the existing image 115 where the simulated anomaly object 110 may be located. Alternatively, or additionally, the training image module 120 may determine the ground truth mask relative to the existing image 115. Referring to the previous example, a ground truth mask associated with the existing image 115 may direct the simulated anomaly 110 to be located on a portion of the roadway and not on a portion of a sidewalk, a building, the sky, etc. In these and other embodiments, the ground truth mask may identify freespace, or portions of the existing image 115 that may be free and/or available for a simulated anomaly object 110 to be located.

In some embodiments, the training image module 120 may generate a bounding object within the training image 122 that may surround the simulated anomaly object 110 within the training image 122. In some embodiments, the bounding object may provide an indication to the machine learning system 125 of the location of the simulated anomaly object 110 within the training image 115. In some embodiments, the bounding object may be a box surrounding the simulated anomaly object 110. For example, in instances in which the simulated anomaly object 110 and/or the existing image 115 include 2D representations (e.g., a 2D simulated anomaly object 110 and/or a 2D existing image 115), the bounding object may be a bounding box, configured to surround and/or identify the simulated anomaly object 110 within the training image 122 (e.g., after being combined with the existing image 115).

Alternatively, or additionally, in instances in which the simulated anomaly object 110 and/or the existing image 115 include 3D representations (e.g., a 3D simulated anomaly object 110 and/or an existing image 115 with a depth component), the bounding object generated by the training image module 120 may be a bounding cube, configured to surround and/or identify the simulated anomaly object 110 within the training image 122 (e.g., after being combined with the existing image 115).

In some embodiments, the existing image 115 may include a static image captured of the operating environment in which the machine learning system 125 is being trained to detect anomaly objects. In some embodiments, the existing image 115 may be captured by a digital camera device, a LiDAR device, a radar device, an ultrasonic device, an infrared device, and/or any other device that may obtain a static image of a scene within the operating environment. In some embodiments, the existing image 115 may include at least some freespace, which freespace may be associated with one or more locations in the existing image 115 where a simulated anomaly object 110 may be located, as described herein. For example, in a driving environment, the freespace may include any drivable surface within the driving environment (e.g., a roadway and not a sidewalk, a building, the sky, etc.). In another example, in a semiconductor environment, the freespace may include open portions of a silicon wafer where semiconductor devices (e.g., transistors, diodes, etc.) may be located.

In these and other embodiments, the training image module 120 may provide the training image 122 to the machine learning system 125 to be used to train the machine learning system 125 to detect an anomaly object in the operating environment, which may be based on the machine learning system 125 detecting the simulated anomaly object 110 in the training image 122. For example, the machine learning system 125 may determine various environmental objects and/or portions of an operating environment may be expected and/or may naturally occur in the operating environment and the machine learning system 125 may determine that an object that may not be included in the environmental objects (e.g., the simulated anomaly object 110) may be an anomaly object in the operating environment. In a driving operating environment, the machine learning system 125 may identify the driving surface and may determine environmental objects that may naturally occur relative to the driving surface (e.g., curbs, man hole covers, painted lines, and/or other environmental objects) and in response to detecting a first object that may not be included in the environmental objects, the machine learning system 125 may flag the first object as an anomaly object. In some embodiments, the machine learning system 125 may be a neural network that may perform object detection. For example, the machine learning system 125 may be a convolutional neural network (CNN), a region-based CNN, a deformable CNN, a single shot detector, a you only look once system, and/or other object detection neural networks.

Modifications, additions, or omissions may be made to the environment 100 without departing from the scope of the present disclosure. For example, the environment 100 may include a data storage that may store at least the training image 122. In some embodiments, the data storage may store multiple training images that may be generated by operations described herein and the multiple training images may be provided to the machine learning system 125 to train the machine learning system 125 as described herein. Alternatively, or additionally, the environment 100 may include any number of other components, actions, or inputs that may not be explicitly illustrated or described.

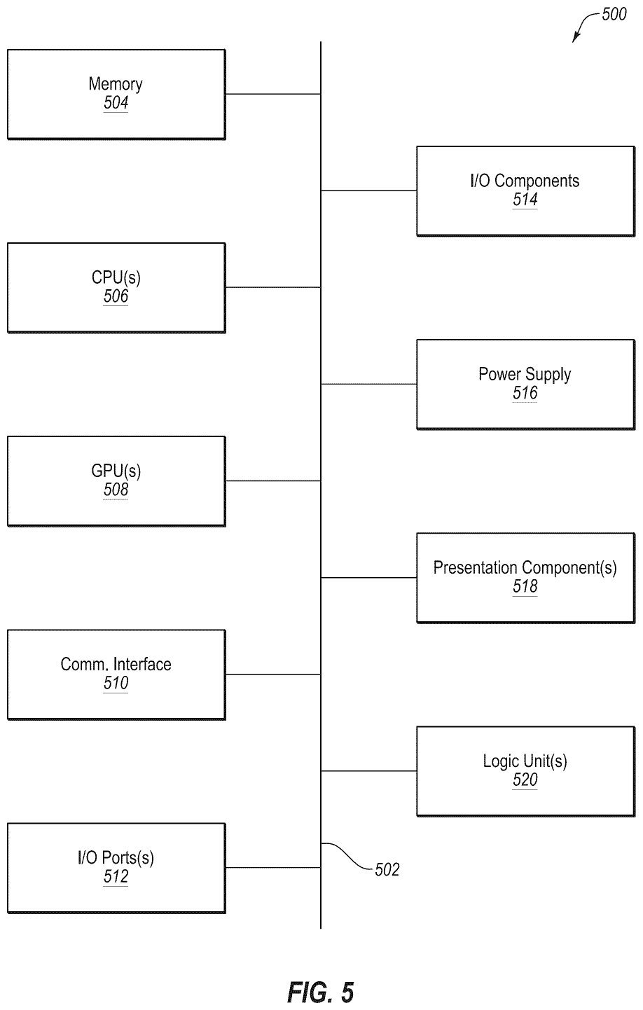

FIG. 2A illustrates an example method 200 for generating a simulated anomaly object for anomaly object detection, according to one or more embodiments of the present disclosure. Each block of the method 200, described herein, may comprise a computing process that may be performed using any combination of hardware, firmware, and/or software. For instance, various functions may be carried out by a processor executing instructions stored in memory. The method 200 may also be embodied as computer-usable instructions stored on computer storage media. The method 200 may be provided by a standalone application, a service or hosted service (standalone or in combination with another hosted service), or a plug-in to another product, to name a few. In addition, the method 200 is described, by way of example, with respect to the environment 100 of FIG. 1. However, these methods may additionally or alternatively be executed by any one system, or any combination of systems, including, but not limited to, those described herein. In these and other embodiments, one or more operations of the method 200 may be performed by one or more computing devices, such as that described in further detail below with respect to FIG. 5. Alternatively, or additionally, FIG. 2B illustrates components 250 of the method 200 for training a machine learning system using simulated anomaly objects, as described relative to FIG. 2A.

The method 200 may include, at block B202, generating a random texture image. In some embodiments, the random texture image may include a color variation between portions of the random texture image. For example, one or more first pixels may be randomly selected within a canvas that may be blank and the first pixels may be assigned a first color. Subsequently, adjacent pixels to the first pixels may be assigned a second color based on a statistical distribution relative to the first color of the first pixels (e.g., where the second color may be the same or may differ from the first color). In some embodiments, the process of assigning colors to pixels adjacent to colored pixel may continue until the pixels included in the canvas are assigned a color and/or the canvas is not blank. In such embodiments, any pixel in the random texture image may be correlated with adjacent pixels and/or the correlation between a pixel and the adjacent pixels may be random. In some embodiments, the statistical distribution of the colors assigned to adjacent pixels may follow any assigning procedure such that a color between adjacent pixels may be correlated. For example, the statistical distribution may be a Markov random field including assigning the colors to adjacent pixels using a Markov process. Alternatively, or additionally, assigning a color to adjacent pixels may be a random distribution, where a color may be randomly for individual pixels in the canvas.

As illustrated by the components 250 of FIG. 2B, a random texture image 252 may be generated on a canvas. In some embodiments, the random texture image 252 may be the same size as the canvas (e.g., as illustrated). Alternatively, or additionally, the random texture image 252 may be any size smaller than the canvas and/or may be sized to be the same or smaller than a size of a simulated anomaly object (e.g., as may be determined using heuristics as described herein). Although illustrated as a grayscale image, the random texture image 252 may include any colors and/or variations of the colors. For example, lighter portions of the random texture image 252 may correspond to a first color and darker portions of the random texture image 252 may correspond to a second color. Alternatively, or additionally, the lighter portions of the random texture image 252 may correspond to a first shade of a color and the darker portions of the random texture image 252 may correspond to a second shade of the color. In these and other embodiments, the variations of the colors within the random texture image 252 may be determined by the statistical process, as described herein, such that the colors of adjacent pixels may be correlated with one another.

At block B204, a random number of points may be generated. In some embodiments, the random number of points may be randomly distributed relative to one another, and/or relative to a drawing canvas in which the random number of points are distributed. In some embodiments, the random number of points may be distributed in a target number of dimensions associated with the simulated anomaly object and/or with the existing image in which the simulated anomaly object may be combined. For example, in instances in which the simulated anomaly object is to be combined with a 2D existing image, the random number of points may be distributed in a two-dimensional space (e.g., a two-dimensional Cartesian coordinate plane, having an X coordinate and/or a Y coordinate). In another example, in instances in which the simulated anomaly object is to be combined with a 3D existing image, the random number of points may be distributed in a three-dimensional space (e.g., a three-dimensional Cartesian coordinate plane, having an X coordinate, a Y coordinate, and/or a Z coordinate).

In some embodiments and as illustrated in FIG. 2B, a random number of points 254 may be generated and/or distributed on a canvas. In some embodiments, the canvas associated with the random number of points 254 may be the same or similar size as the canvas associated with the random texture image 252. For example, the random number of points 254 may be distributed such that a convex polygon 256 obtained relative to the random number of points 254, as described below, may not be larger than the random texture image 252.

At block B206, a convex polygon may be obtained relative to the random number of points. In some embodiments, the convex polygon may be obtained by determining a convex hull of the random number of points. For example, the convex polygon may be a polygon that includes all of the random number of points in the smallest convex set that includes the random number of points. In some embodiments, the convex polygon may be 2D or 3D, which may be based on the number of dimensions associated with the random number of points. In some embodiments, one or more convex polygons may be obtained based on the generated random number of points described in block B204. That is to say, more than one convex polygon may be generated using the generated random number of points. Alternatively, or additionally, one or more sets of a random number of points may be generated and may be used to obtain one or more convex polygons. For example, in instances in which three sets of a random number of points are generated, at least three convex polygons may be obtained (e.g., one or more convex polygons per set of random number of points).

In some embodiments and as illustrated in FIG. 2B, the convex polygon 256 may be obtained relative to the random number of points 254, such as by determining a convex hull of the random number of points 254. In some embodiments, generating the random number of points 254 and subsequently obtaining the convex polygon 256 may be performed subsequent to generating the random texture image 252. Alternatively, or additionally, generating the random number of points 254 and obtaining the convex polygon 256 may be performed before generating the random texture image 252 or may be performed in parallel with generating the random texture image 252.

At block B208, an object part may be obtained by combining the convex polygon with the random texture image. In some embodiments, the convex polygon may overlay a portion of the random texture image and the portion of the random texture image having the shape of the convex polygon may be the object part.

In some embodiments and as illustrated in FIG. 2B, the convex polygon 256 may be combined with the random texture image 252 to be the combined image 258. For example, the convex polygon 256 may overlay at least a portion of the random texture image 252 and combined may be the combined image 258. In some embodiments, the convex polygon 256 in the combined image 258 may be arranged relative to the random texture image 252 such that all of the convex polygon 256 is within the boundary (e.g., the canvas) of the random texture image 252. Alternatively, or additionally, in instances in which the combined image 258 includes a portion of the convex polygon 256 that extends beyond the boundary of the random texture image 252, the shape of the convex polygon 256 may be modified to be constrained relative to the boundary of the random texture image 252 (e.g., the portions of the convex polygon 256 that extend beyond the boundary of the random texture image 252 may be trimmed to be the same or similar as the boundary of the random texture image 252).

At block B210, a random rotation and/or a random translation may be performed relative to the object part. For example, the object part may include a first rotation and/or a first translation. Alternatively, or additionally, a second random rotation may be performed relative to the object part, where the second random rotation may be in an orthogonal plane to the random rotation, such that the object part may be a 3D object in a 3D space.

In some embodiments and as illustrated in FIG. 2B, an object part 260a may be rotated and/or translated relative to the convex polygon 256 combined with the combined image 258. For example, the object part 260a may be rotated and/or translated relative to the convex polygon as generated 256 and/or the convex polygon 256 combined with the random texture image 252 as shown in the combined image 258. In these and other embodiments, the object part 260amay be a component of a simulated anomaly object (as described relative to block B214 herein) and/or the object part 260a may be combined with one or more additional object parts, where the combination of the object part 260a with the one or more additional object parts may be the simulated anomaly object.

At block B212, a decision as to whether a number of object parts (e.g., the object part as generated by the operations described in blocks B202, B204, B206, B208, and B210) satisfies a threshold value relative to a number of object parts to be included in the simulated anomaly object may be determined. In instances in which the number of object parts fails to satisfy the threshold value, the operations described relative to blocks B202, B204, B206, B208, and/or B210 may be repeated such that one or more additional object parts may be generated. For example, in instances in which the number of object parts fails to satisfy the threshold value, an additional random texture image may be generated, an additional set of a random number of points may be generated, an additional convex polygon may be obtained relative to the additional random number of points, an additional object part may be obtained, and/or a rotation and/or a translation of the object part may be performed, all of which may be in accordance with the operations described in blocks B202, B204, B206, B208, and/or B210, respectively. For example, and as illustrated in FIG. 2B, an additional object part 260b may be obtained using one or more of the operations described in blocks B202, B204, B206, B208, and/or B210.

Alternatively, or additionally, the respective results of previous performance of one or more of the operations (and/or the results of the operations) described in blocks B202, B204, B206, B208, and/or B210 may be reused to generate the additional object part. For example, an additional convex polygon may be obtained from an additional set of a random number of points and may be combined with the random texture image from block B202 to obtain the additional object part. In another example, an additional random texture image may be generated and combined with the convex polygon obtained from block B206 to obtain the additional object part.

Alternatively, in instances in which the number of object parts satisfies the threshold value, the method may continue to block B214. In these and other embodiments, the threshold value may be one, such that the object part generated in accordance with the operations described in blocks B202, B204, B206, B208, and B210 may satisfy the threshold number of object parts. In some embodiments, the threshold for the number of object parts included in the simulated anomaly object may be based on the size of the simulated anomaly object relative to the existing image and/or objects included in the existing image. For example, an object size relative to an object included in the existing image may be determined and the threshold may be determined relative to the object size (e.g., the threshold may be larger in instances in which the simulated anomaly object is closer than the respective object and/or the threshold may be smaller in instances in which the simulated anomaly object is further than the respective object). Alternatively, or additionally, the threshold for the number of object parts included in the simulated anomaly object may be based on a number of pixels associated with the simulated anomaly object. For example, the threshold may be a determined number of pixels (e.g., based on a number of pixels associated with an object in the existing image) and once the simulated anomaly object satisfies the threshold (e.g., by including at least the determined number of pixels), the method may continue to block B214.

At block B214, the simulated anomaly object may be generated using at least the object part. In instances in which more than one object part is included in the simulated anomaly object, a first random pixel may be selected relative to the object part and a second random pixel may be selected relative to an additional object part, and the object part may be joined with the additional object part by aligning the first random pixel with the second random pixel and/or joining the first random pixel with the second random pixel. In instances in which the object part and/or the additional object part is a 3D object, the simulated anomaly object may be a 3D simulated anomaly object.

In some embodiments and as illustrated in FIG. 2B, a simulated anomaly object 264 may be obtained by combining the object part 260a and the additional object part 260b. In some embodiments, at least a portion of the simulated anomaly object 264 may have the same or similar size and/or shape of the convex polygon 256 (e.g., the same or similar size and/or shape of the object part 260a) and/or the simulated anomaly object 264 may include the same or similar texture as at least a portion of the random texture image 252. As illustrated, the simulated anomaly object 264 may be include a combination of the object part 260a and the additional object part 260b. It will be appreciated that the simulated anomaly object 264 may include any number of object parts, including just the object part 260a, the object part 260a and the additional object part 260b, and/or one or more additional object parts, as described by the method 200 of FIG. 2A.

Modifications, additions, or omissions may be made to the method 200 without departing from the scope of the present disclosure. For example, in some embodiments, block B210 may be omitted from the method 200, such that the object part 260a (and/or the additional object part 260b) may not be rotated and/or translated. In such instances, the object part 260a may be included in the simulated anomaly object 264 without a rotation and/or a translation. In another example, the method 200 may include combining more than the object part 260a and the additional object part 260b (with associated rotations and/or translations) to form the simulated anomaly object 264. For example, any number of object parts may be generated (e.g., using the operations described relative to blocks B202, B204, B206, B208/B210, and/or B212) and the object parts may be combined to generate the simulated anomaly object.

Further, in instances in which more than one object part is included in the simulated anomaly object 264, obtaining the object parts may be performed in parallel. For example, components forming a first object part (e.g., the object part 260a) and components forming a second object part (e.g., the additional object part 260b) may be combined in parallel such that the first object part and the second object part may be obtained at substantially the same time.

Alternatively, or additionally, obtaining the first object part and the second object part may be performed sequentially, where the first object part may be obtained (and/or rotated and/or translated) and the second object part may be obtained thereafter. In such instances, the first object part may be a temporary simulated anomaly object and upon the first object part combining with the second object part, the combination of the first object part and the second object part may be the temporary simulated anomaly object. The temporary simulated anomaly object may continue to be updated (e.g., with subsequent object parts) until a threshold is satisfied and the temporary simulated anomaly object becomes the simulated anomaly object 264 (e.g., as described in B214). In some embodiments, the threshold may . . . , Alternatively, or additionally, the method 200 may include any number of other components, actions, or inputs that may not be explicitly illustrated or described.

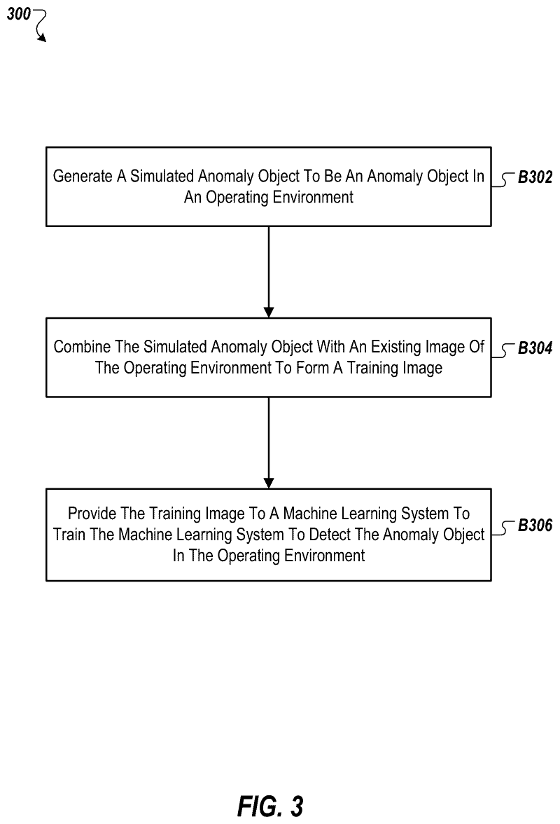

FIG. 3 illustrates an example method 300 for training a machine learning system to detect anomaly objects, according to one or more embodiments of the present disclosure. Each block of the method 300, described herein, may comprise a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, the method 300 is described, by way of example, with respect to the environment 100 of FIG. 1. However, these methods may additionally or alternatively be executed by any one system, or any combination of systems, including, but not limited to, those described herein. In these and other embodiments, one or more operations of the method 300 may be performed by one or more computing devices, such as that described in further detail below with respect to FIG. 5.

The method 300 may include, at block B302, generating a simulated anomaly object in an operating environment. In some embodiments, the simulated anomaly object may be distinct from objects and/or portions of the operating environment. In some embodiments, the simulated anomaly object may be an abstract object and may have one or more randomly generated features. In some embodiments, the one or more randomly generated features may include a randomly generated texture. Alternatively, or additionally, the one or more randomly generated features may include convex polygon obtained using a convex hull obtained from a random number of randomly distributed points. In these and other embodiments, the convex polygon may be combined with the randomly generated texture to obtain a first object part. In some embodiments, the simulated anomaly object may include a combination of a first object part and a second object part. In some embodiments, the second object part may be obtained similar to the first object part, using randomly generated texture and a convex polygon obtained using a random number of randomly distributed points (any and/or all of which may differ from the components associated with the first object part, e.g., the randomly generated texture and the convex polygon obtained using a convex hull obtained from a random number of randomly distributed points).

Alternatively, or additionally, the simulated anomaly object may include a first object part that may be randomly rotated and/or randomly translated and/or a second object part that may be randomly rotated and/or randomly translated. Alternatively, or additionally, a first random pixel may be selected from the first object part, a second random pixel may be selected from the second object part, and the first object part may be joined with the second object part by joining the first random pixel with the second random pixel.

In some embodiments, a simulated anomaly object size may include at least an upper threshold and/or a lower threshold. For example, the upper threshold may constrain how large the simulated anomaly object size may be and/or the lower threshold may constrain how small the simulated anomaly object size may be. In these and other embodiments, the simulated anomaly object size, the upper threshold, and/or the lower threshold may be associated with the operating environment. For example, in instances in which the operating environment is a driving environment, the simulated anomaly object size may be scaled between the lower threshold and the upper threshold of objects associated with the driving environment, such as pebbled-sized objects and/or tractor-trailer-sized objects. In another example, in instances in which the operating environment is an integrated circuit manufacturing environment, the simulated anomaly object size may be scaled between the lower threshold and the upper threshold of objects associated with the integrated circuit manufacturing environment, such as nanometer-sized objects (e.g., transistors) and/or micrometer/millimeter-sized objects.

In these and other embodiments, in instances in which a simulated anomaly object is larger than the upper threshold or smaller than the lower threshold, the simulated anomaly object may be resized such that the simulated anomaly object may be smaller than the upper threshold and larger than the lower threshold. In some embodiments, the resizing of the simulated anomaly object may be performed automatically and/or randomly. For example, in instances in which a simulated anomaly object is smaller than the lower threshold, the simulated anomaly object may be automatically resized to be greater than the lower threshold, where the resized simulated anomaly object may or may not be an equivalent size of the lower threshold.

In these and other embodiments, the simulated anomaly object size may be determined using heuristics, including making a determination based on an existing image, the operating environment as displayed within the existing image, and/or objects within the operating environment. For example, the simulated anomaly object size may be determined using a focal distance associated with the existing image and/or a relative size of at least one existing object in the operating environment (as obtained from the existing image). In these and other embodiments, the simulated anomaly object size may be similar in size to one or more objects in the operating environment and/or scaled based on the one or more objects in the operating environment. For example, in instances in which the operating environment is a driving environment, the simulated anomaly object size may be smaller than an automobile included in the operating environment, as the simulated anomaly object may be sized to be similar to an anomaly the automobile may encounter during operation in the operating environment, such as a construction cone.

As such, in some embodiments, the simulated anomaly object may be generated by generating a simulated object based at least on extracting a portion of the simulated object from a simulated textured representation. Additionally, as discussed, the portion of the simulated object may be retrieved from a portion of the simulated textured representation based at least on one of a random number of randomly distributed points or a convex polygon.

At block, B304, the simulated anomaly object may be combined with an existing image of the operating environment. The combination of the simulated anomaly object and the existing image may form a training image. In some embodiments, the combination of the simulated anomaly object and the existing image may be performed automatically. For example, in response to an existing image that does not include a simulated anomaly object, a simulated anomaly object may be generated and automatically combined with the existing image to form the training image.

In some embodiments, the existing image may include an object mask that may direct one or more object locations within the operating environment in which the simulated anomaly object may be located. In some embodiments, the existing image may be a freespace image that may include a ground truth of the operating environment. For example, the freespace image may include an image captured using a sensor device (e.g., a digital camera, a lidar device, etc.) of the operating environment. Alternatively, or additionally, the ground truth that may be part of the freespace image may define one or more portions of the operating environment displayed in the freespace image in which the simulated anomaly object may be located. For example, in a driving environment, the freespace image may include a portion of a road with one or more cars located thereon, and the ground truth may include one or more portions of road surfaces in the freespace image, that may not be obstructed, such as by the one or more cars, pedestrians, and/or other objects.

In some embodiments, a bounding box may be generated around the simulated anomaly object in response to the forming of the training image, such that the training image may include a bounding box associated with the simulated anomaly object. Alternatively, or additionally, the bounding box may be a cuboid structure (e.g., similar to the bounding box and including a depth), such that the bounding box may be around a 3D simulated anomaly object.

At block, B306, the training image may be provided to a machine learning system. In some embodiments, the training image may train the machine learning system to detect at least the anomaly object in the operating environment. For example, one or more parameters of the machine learning model may be updated based at least on the training image and ground truth data corresponding to the training image, such as data indicating that the simulated anomaly object is an anomalous object in the operational environment.

As such, in some embodiments, the machine learning system may detect an anomaly object within the operating environment based on the anomaly object not belonging in the operating environment and/or without regard to an object class associated with the anomaly object. For example, the machine learning system trained using the training images described herein may detect a construction cone, an airbag, rocket debris, etc., as an anomaly object that may not belong in the operating environment, and the machine learning system may or may not determine an object class associated with the anomaly object (e.g., a construction code, an airbag, rocket debris, etc.).

Modifications, additions, or omissions may be made to the method 300 without departing from the scope of the present disclosure. For example, in some embodiments, the training image may be segmented and a portion of the training image that corresponds to the simulated anomaly object may be labelled as the anomaly object. For example, the training image may be segmented into a pixel-by-pixel representation and the pixels that correspond to the simulated anomaly object may be labelled as the anomaly object, such that the machine learning system that may be trained using the training image may associate the simulated anomaly object with the anomaly object in the operating environment.

Although illustrated as discrete blocks, various blocks of the method 300 may be divided into additional blocks, combined into fewer blocks, or eliminated, depending on the desired implementation.

### EXAMPLE AUTONOMOUS VEHICLE

FIG. 4A is an illustration of an example autonomous vehicle 400, in accordance with some embodiments of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. For example, the vehicle 400 may be capable of conditional automation (Level 3), high automation (Level 4), and/or full automation (Level 5), depending on the embodiment.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more CPU(s), system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, and/or to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems sensor(s) 458 (e.g., Global Positioning System sensor(s)), RADAR sensor(s) 460, ultrasonic sensor(s) 462, LIDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 560 degree cameras), long-range and/or mid-range camera(s) 498, speed sensor(s) 444 (e.g., for measuring the speed of the vehicle 400), vibration sensor(s) 442, steering sensor(s) 440, brake sensor(s) 446 (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the HD map 422 of FIG. 4C), location data (e.g., the location of the vehicle 400, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 54B in two miles, etc.).

The vehicle 400 further includes a network interface 424, which may use one or more wireless antenna(s) 426 and/or modem(s) to communicate over one or more networks. For example, the network interface 424 may be capable of communication over LTE, WCDMA, UMTS, GSM, CDMA2000, etc. The wireless antenna(s) 426 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 4B is an example of camera locations and fields of view for the example autonomous vehicle 400 of FIG. 4A, in accordance with some embodiments of the present disclosure. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 520 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that includes portions of the environment in front of the vehicle 400 (e.g., front-facing cameras) may be used for surround view, to help identify forward-facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may any number of wide-view cameras 470 on the vehicle 400. In addition, long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

One or more stereo cameras 468 may also be included in a front-facing configuration. The stereo camera(s) 468 may include an integrated control unit comprising a scalable processing unit, which may provide a programmable logic (e.g., FPGA) and a multi-core micro-processor with an integrated CAN or Ethernet interface on a single chip. Such a unit may be used to generate a 3D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that includes portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned around the vehicle 400. The surround camera(s) 474 may include wide-view camera(s) 470, fisheye camera(s), 360-degree camera(s), and/or the like. For example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround-view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an example system architecture for the example autonomous vehicle 400 of FIG. 4A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C is illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400 and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use computer-based application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting, and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined LI data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 306 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected to both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 404 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-3 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. For example, the PVA may be used to process raw RADAR data (e.g., using a 4D Fast Fourier Transform) to provide a processed RADAR signal before emitting the next RADAR pulse. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LIDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 416 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe-stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. An in-cabin monitoring camera sensor is preferably monitored by a neural network running on another instance of the advanced SoC, configured to identify in-cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and actively performing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LIDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provide semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always-on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, which use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include an SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428, which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 485 (e.g., GPS and/or assisted GPS sensors), to assist in mapping, perception, occupancy grid generation, and/or path planning functions. Any number of GNSS sensor(s) 458 may be used, including, for example and without limitation, a GPS using a USB connector with an Ethernet to serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data, in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the surrounding of the vehicle 400 at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor system may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LIDAR sensor(s) 464. The LIDAR sensor(s) 464 may be used for object and pedestrian detection, emergency braking, collision avoidance, and/or other functions. The LIDAR sensor(s) 464 may be functional safety level ASIL B. In some examples, the vehicle 400 may include multiple LIDAR sensors 464 (e.g., two, four, six, etc.) that may use Ethernet (e.g., to provide data to a Gigabit Ethernet switch).

In some examples, the LIDAR sensor(s) 464 may be capable of providing a list of objects and their distances for a 360-degree field of view. Commercially available LIDAR sensor(s) 464 may have an advertised range of approximately 500 m, with an accuracy of 2 cm-3 cm, and with support for a 500 Mbps Ethernet connection, for example. In some examples, one or more non-protruding LIDAR sensors 464 may be used. In such examples, the LIDAR sensor(s) 464 may be implemented as a small device that may be embedded into the front, rear, sides, and/or corners of the vehicle 400. The LIDAR sensor(s) 464, in such examples, may provide up to a 520-degree horizontal and 35-degree vertical field-of-view, with a 200 m range even for low-reflectivity objects. Front-mounted LIDAR sensor(s) 464 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 400. Available 3D flash LIDAR systems include a solid-state 3D staring array LIDAR camera with no moving parts other than a fan (e.g., a non-scanning LIDAR device). The flash LIDAR device may use a five nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include an SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LIDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjusts the vehicle speed to maintain a safe distance from vehicles ahead. Lateral ACC performs distance keeping, and advises the vehicle 400 to change lanes when necessary. Lateral ACC is related to other ADAS applications such as LC and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication links. In general, the V2V communication concept provides information about the immediately preceding vehicles (e.g., vehicles immediately ahead of and in the same lane as the vehicle 400), while the I2V communication concept provides information about traffic farther ahead. CACC systems may include either or both I2V and V2V information sources. Given the information of the vehicles ahead of the vehicle 400, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. An LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane.

BSW systems detect and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 460, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output can be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity make the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware used by the primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network that is trained and thus reduces the risk of false positives, as described herein.

The vehicle 400 may further include the infotainment SoC 430 (e.g., an in-vehicle infotainment system (IVI)). Although illustrated and described as an SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 400. For example, the infotainment SoC 430 may include radios, disk players, navigation systems, video players, USB and Bluetooth connectivity, carputers, in-car entertainment, Wi-Fi, steering wheel audio controls, hands-free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe-stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some embodiments of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced roadwork. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### EXAMPLE COMPUTING DEVICE

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, I/O ports 512, input/output components 514, a power supply 516, one or more presentation components 518 (e.g., display(s)), and one or more logic units 520.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” “augmented reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point, connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), I/O elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, including wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 512 may enable the computing device 500 to be logically coupled to other devices including the I/O components 514, the presentation component(s) 518, and/or other components, some of which may be built into (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, etc.), and output the data (e.g., as an image, video, sound, etc.).

### EXAMPLE DATA CENTER

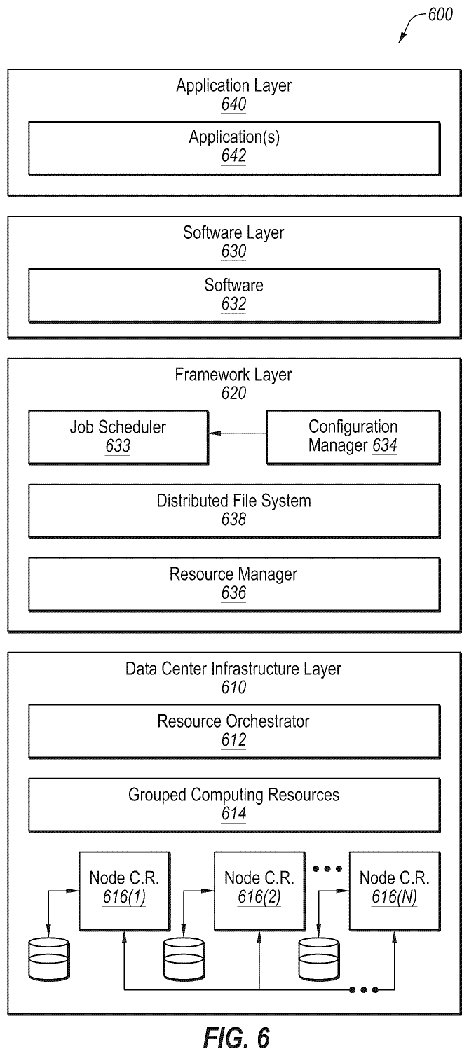

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1) 616(N), where “N” represents any whole, positive integer. In at least one embodiment, node C.R.s 616(1) 616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1) 616(N) may correspond to a server having one or more of the above-mentioned computing resources. In addition, in some embodiments, the node C.R.s 616(1) 616(N) may include one or more virtual components, such as vGPUs, vCPUs, and/or the like, and/or one or more of the node C.R.s 616(1) 616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1) 616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 633, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 633 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 633. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1) 616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1) 616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand- held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Further, use of the term “based at least on” in the present disclosure or claims does not mean that omission of “at least” in other places term means “only”. For example, use of the term “based on X” in the present disclosure or claims may also mean “based at least on X” even though the term “at least” is not used in the particular instance but is used elsewhere.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating a simulated object based at least on extracting at least a portion of the simulated object from a simulated textured representation;
combining the simulated object with an existing image to generate a training image; and
updating one or more parameters of a machine learning model based at least on the training image and ground truth data corresponding to the training image.

2. The method of claim 1, wherein the simulated object comprises at least the first portion combined with a second portion.

3. The method of claim 1, wherein the portion of the simulated object is retrieved from a portion of the simulated textured representation based at least on one of a random number of randomly distributed points or a convex polygon.

4. The method of claim 1, wherein:
the simulated object comprises the first portion that is randomly rotated and randomly translated and a second portion that is randomly rotated and randomly translated; and
the first portion is joined with the second portion based at least on joining a first randomly selected pixel from the first portion with a second randomly selected pixel from the second portion.

5. The method of claim 1, wherein the existing image includes an object mask associated therewith that directs one or more object locations within the existing image that the simulated object may be located.

6. The method of claim 1, wherein the existing image includes a freespace representation associated therewith that directs one or more object locations within the existing image that the simulated object may be located.

7. The method of claim 1, further comprising, in response to the training image being generated, generating a bounding shape around the simulated object to be included in the ground truth data.

8. The method of claim 1, wherein:
a size of the simulated object comprises an upper threshold and a lower threshold; and
the size, the upper threshold, and the lower threshold are determined based at least on one or more characteristics of an environment as depicted in the existing image.

9. The method of claim 8, wherein the size of the simulated object is determined using heuristics based on at least one of a focal distance and a relative size of at least one existing object in the environment.

10. The method of claim 1, further comprising:
segmenting the training image; and
labelling a portion of the segmented training image that includes the simulated object as the anomaly object,
wherein a resulting label from the labelling is included in the ground truth data.

11. The method of claim 1, wherein the simulated object is automatically combined with the existing image to generate the training image.

12. A system comprising:
one or more processing units to:
generate one or more simulated objects from one or more textured images based at least on one or more randomly generated shapes; and
updating one or more parameters of a machine learning model using the one or more simulated objects and ground truth data corresponding to the one or more simulated objects.

13. The system of claim 12, wherein at least one simulated object of the one or more simulated objects includes one or more randomly generated features comprising at least one of a random texture, a random number of randomly distributed points, a convex polygon, or the convex polygon combined with the random texture.

14. The system of claim 12, wherein:
one or more sizes of the one or more simulated objects comprises an upper threshold and a lower threshold; and
the size, the upper threshold, and the lower threshold are associated with an environment corresponding to one or more existing images that the one or more simulated object are included.

15. The computing system of claim 14, wherein the one or more sizes of the one or more simulated objects is determined using heuristics based one at least one of a focal distance and a relative size of at least one existing object in the environment.

16. The computing system of claim 12, wherein the computing system comprises one or more of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one virtual reality content, augmented reality content, or mixed reality content;
a system implemented using a robot;
a system for performing conversational AI operations;
a system for generating synthetic data;
a system incorporating one or more virtual machines (VMs);
a system implementing one or more large language models (LLMs);
a system implemented at least partially in a data center; or a system implemented at least partially using cloud computing resources.

17. A processor comprising processing circuitry to perform operations comprising:
generating a simulated anomaly object based at least on one or more randomly generated shapes;
combining the simulated anomaly object with an existing image of an operating environment to form a training image; and
providing the training image to a machine learning system to train the machine learning system to detect an anomaly object in an operating environment based at least on the simulated anomaly object.

18. The processor of claim 17, wherein the existing image includes an object mask associated therewith that directs one or more object locations within the existing image that the simulated anomaly object may be located.

19. The processor of claim 17, further comprising, in response to the forming of the training image, generating a bounding object around the simulated anomaly object, and associating the bounding shape with the training image.

20. The processor of claim 17, wherein the processor is comprised in one or more of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one virtual reality content, augmented reality content, or mixed reality content;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
